(19) United States
(12) Patent Application Publication
(10) Pub. No.: US 2018/0218238 A1
(43) Pub. Date: Aug. 2, 2018

(54) Human-Artificial Intelligence Hybrid System

(71) Applicant: James Peter Tagg, Crockham Hill (GB)

(72) Inventors: Erik Viirre, San Diego, CA (US); James Peter Tagg, Edenbridge (GB)

(21) Appl. No.: 15/420,028

(22) Filed: Jan. 30, 2017

(51) Int. Cl. G06K 9/62; G06N 5/00; G06N 5/02

(52) U.S. Cl. CPC G06K 9/6254; G06N 5/025; G06N 5/003

(57) ABSTRACT

A system allowing human intelligence and artificial intelligence to participate in the solving of a problem together, in real time, allowing the human to tag a data set of complex interactions to indicate where the failures are and to develop a system based on this dataset that learns heuristic rules to detect when a failure is likely and to automatically request further human assistance.

### CROSS-REFERENCE TO RELATED APPLICATIONS

There are no related patents.

### BACKGROUND OF THE INVENTION

Humans are highly creative. We make art, invent products, compose music and prove mathematical theorems. Humans have Human Intelligence (HI) and are engaged in the process of building Artificial Intelligence (AI). Non-computable problems are problems which involve non-recursive mathematics and are theoretically inaccessible to AI. HI appears to be able to solve such non-computable problems and is also extremely energy and space efficient in general. Therefore, a combination of HI and AI in an effective manner, particularly for the solution of non-computable problems would be of great benefit. It is argued in this patent that non-computable problems are more common than is normally believed, that a solution to solving such problems using a combination of is Human Intelligence and Artificial Intelligence is an important advance, and a solution is presented. The proposed solution has generality across many forms of problem in the computational hierarchy and is not only applicable to non-recursive classes.

In order to distinguish between Human Intelligence and Artificial Intelligence, it is necessary to review the purposes and operation of Artificial Intelligence (AI). AIs are constructed to have faculties of perception (input), to recognize and record abstract information (memory), to provide “reasoning” in the interpretation of data that has an uncertain causal basis of connection or operation (processing), and to prescribe actions to be carried out in the face of circumstances based on explicit or statistical rules (output). These perceptual, memory, reasoning and action determination capabilities are called Artificial Intelligence (AI) (see USPTO class definition 706). AIs carry out very large volumes of computation and have perfect and immediate memory for data. They are deterministic and are implemented by digital computation which is equivalent, in the limits of infinite time and memory, to a Turing Machine. For a comprehensive review of AI, the reader is referred to Artificial Intelligence: A Modern Approach, 2016 by Stuart Russell and Peter Norvig. For a review of current deep learning neural network approaches the reader is referred to http://tensorflow.org or http://torch.ch.

AI capabilities are applied in many different fields, examples include; recognition of two or three dimensional images from photonic sensing systems (artificial vision), determination of “rules” of connection between linked sources of data (machine learning), automated solution of abstract problems such as mathematical theorem proving and game playing such as Chess or Go. Both programming (or “training”) of the digital systems and operation of the digital systems are needed to carry out the AI actions. For example, in an AI perception system, a digital computer may be presented with many examples of “tagged” data (images of a classes, such as “Cats and Cheetahs”) and either through explicit programming for examination of features, or through methods not directly programmed such as deep learning neural networks, the system will learn to classify the object. Then, in operation, a data set will be presented to the system and the system may determine if the data set represents a previously presented image, a new image but a member of one of the classes or whether the image is not a class member.

Human Intelligence (HI), on the other hand, appears to work through the application of intuition and instinct. There is little agreement on whether these terms are realised in a different fashion to digital computation but it is generally agreed that HIs are very power efficient, can be trained from a single example and apply common sense to problems, that is to say is it difficult to fool them with datasets that have the characteristics of an object but are not of that class of object. We call this faculty understanding. HIs appear to understand the nature of being Cat like or Cheetah like as opposed to brute force computing set membership. HIs are not infallible, they can be fooled by a variety of optical illusions. HIs and AIs tend to be approach problems differently and are successful or fail in different ways therefore an efficient method to assign tasks to one, the other or both would be of great benefit.

One example of the difference between human and artificial intelligence is in the approach to games such as Chess and Go. Humans skilled in such games use a variety of heuristics, such as recognition of standard game configurations, whereas AIs approach such games using rules and the calculation of very large numbers of possible steps, along with the computation of fitness functions through the analysis of hundreds of millions of games.

In many fields the combination of human and artificial intelligence can outperform either alone. In the case of Chess this is known as “Centaur Chess”. Humans and machines may be deployed together to play the game and the combination will operate better than either individually. It should be noted that chess and Go are computable problems, it is the extremely high number of permutations which renders them intractable. Chess at around 10³⁴ permutations and Go a staggering 10¹⁷⁰ permutations—greater than the number of particles in The Observable Universe.

Many problems we wish to solve are non-computable (NC) in principle—incapable of being computed by any deterministic algorithm in any finite amount of time. For, example Rice's theorem says that any non-trivial feature of a computer program is non-computable. Humans don't appear to be limited by such non-computability. In particular, we write software that are productively functional without being aware of any such a hard limit.

There has not been a general attempt, as yet, to tackle non-computable problems using the centaur model of HI and AI combinations. This is partly because, up until now, there has been no easy way to classify such non-computable problems. There is also some controversy as to whether non-computable problems occur in common experience. It is argued, that although non-computable problems exist in principle, we either, never encounter them in practise or, are able to solve them approximately without exceeding the capability of a Turing machine. In this patent, we argue this is incorrect and a system which can blend human and artificial intelligence will, in principle, exceed the capability of artificial intelligence alone. This would imply that a human-artificial intelligence hybrid system is slightly more powerful than a Turing machine. Even if this were not the case, in principle, humans are dramatically more computationally efficient than AI systems for some problems and marrying the two will bring practical benefit regardless of agreement on the fundamental mathematics. We will now present the argument that human intelligence exceeds, as a matter of principle, the capability of artificial intelligence.

Humans invent, compose music, write novels and discover things. We consider these to be creative pursuits and often colloquially describe them in non-computable terms. A poor piece of art or music is described as formulaic and a fractal is not considered art. We would like to use this notion of non-computability as the definition of intelligence but intelligence and creativity do not have a strictly codified rule set so it is difficult to prove a particular work is the product of a non-computable function. If we are to best characterize non-computability as a defining feature of creativity, we must look to the field of mathematics. With mathematics, we do have a formal distinction between computable and non-computable functions. The field is called decidability and was initiated by David Hilbert and was codified in Turing's famous 1936 paper. “On computable numbers and their application to the Entscheidungsproblem”. In order to prove some piece of mathematical creativity is non-computable we need to find a problem where the discovery of a proof is a strictly non-computable task and then find a proof of that problem by a human being.

At the turn of the last century David Hilbert, a German mathematician, set out twenty one important questions in mathematics many of which have entered popular culture: The Riemann hypothesis, the Poincare conjecture and whether or not there is an effective method of solving Diophantine equations. In 1926 Hilbert summarized his thoughts on mathematics into three more general questions: Was mathematics complete, consistent and decidable? This approach to mathematics was known as formalism.

There is a small confusion caused by an alternate use of the term decidable. The continuum hypothesis, Hilbert's 1st problem, is ‘undecidable’ in Zermelo-Fraenkel set theory with the axiom of choice: This means a proof cannot be found (in legal parlance there is insufficient evidence). Someone—in this case Martin Davis—has made a proof that there can be no proof given our currently understood, consistent, mathematical model. This is a different meaning of the word undecidable, namely insoluble. In this document, we will use undecidable to mean there is no algorithmic way to determine whether a problem is solvable (either in the positive, negative or impossible sense). It follows that there is also no way to find a proof of any undecidable problem otherwise we could use the proof to determine whether the problem was decidable. This definition of undecidable is equivalent to saying something is non-computable or there is no effective method for solving the problem.

Undecidable problems always refer to matters of mathematical principle. There must be some iteration over an infinite set involved. For example, “There can be no number such that . . . ” If the problem were finite we could always iterate through every possible scenario until we found a solution. Finite problems are always decidable—albeit often in impractical quantities of time and space. But finite problems are rare. We usually want to understand the ‘why’ of something rather than just heuristically test lots of possibilities.

The term algorithm also requires a brief definition. Before the advent of computers, the normal term used by mathematicians was ‘effective method’ or ‘decision procedure’. Long division is an effective method; you simply execute the procedure with pencil and paper and it will yield the correct result every time. At the beginning of the last century computers were people! Richard Feynman's first job was to calculate for the Manhattan project. With the advent of digital computers, we now define the notion of an effective method as there being an algorithm to solve a given class of problem. If a class of problems has an algorithm it is said to be decidable. There is clearly an algorithm to perform long division on any set of natural numbers so, in principle, all long division problems are decidable.

Taking these modern ideas into account we can translate Hilbert's 10th question into: Is there one algorithm to solve any arbitrary Diophantine Equation, or put another way are all Diophantine Equations decidable by a single algorithm? These questions are essentially the same. If there was an algorithm that could solve an arbitrary (read random) Diophantine Equation, we could run a Monte Carlo process and eventually cover every possible equation. Equally an equation that can solve all problems can clearly solve any individual problem chosen at random.

One very important concept is this issue of ‘one algorithm’. If I have two algorithms or a set of algorithms and I have a method for choosing which is to apply this system is really one algorithm. Internally it has structure: pick the type of problem you are solving, use the subroutine for that type of problem, end. But seen from a distance you simply put a problem in one end and get an answer out of the other. Since we are talking about the inability of finding one algorithm to perform a task it is important to realize that collections of algorithms organized by another algorithm form one algorithm. It follows that if you consider all of existence to be algorithmic then there is one Universal algorithm running. This is the computable Universe hypothesis, the notion that our Universe is a computation.

For Hilbert and the formalists, the first question to fall was completeness. In 1931 Kurt Güdel showed mathematics was incomplete and in the following year he clarified this proof to say mathematics could be complete but in this case, it would be inconsistent. In 1936 Alan Turing and Alonzo Church answered the question of decidability. Church, using lambda calculus, and Turing, using the idea of an idealized computing machine showed the decision problem, ‘The Entscheidungsproblem’, has no solution. From this point, onwards we knew all problems are not susceptible to a single algorithm. However, we did not know much about whether a given problem or type of problem is susceptible to solution by an algorithm.

### Logic Limit

Turing showed us that all problems cannot be decided but we also know some problems can be decided, multiplication, division and the like. There must, therefore, be a boundary, a ‘logic limit’. The point at which our currently known set of algorithms can no longer solve a problem and where something more must take over. If we imagine that the computable hypothesis is true, there will also be a Universal logic limit. The boundary of knowledge that our Universe as a whole is capable of solving given its currently know Universal algorithm.

Where is the logic limit and what form does it take? Is it a clear line over which we can step and then the whole of creation is set out before us or is it more like a set of compartments that must be explored sequentially. Are these compartments of knowledge large or small and are they ordered and similar in size of do they form some apparently random structure. It turns out that we can use Turing's original proof to explore decidability in all branches of mathematics.

Progress on the logic limit for mathematics was made steadily through the early 20^{th} century. In 1928 Paul Bernays and Moses Schönfinkel prove that sentences in first order predicate calculus with the form *∀ have a decision procedure. In 1928 Wilhelm Ackerman prove *∀ also have a decision procedure. In 1933 Gödel showed sentences of the form ∀³* constitute a reduction class, meaning if this type of problem is solvable then all are. However once Church and, Turing prove there can be no general decision procedure all these reduction classes were confirmed undecidable. Finally in 1962 Richard Büchi showed equations even as simple as ∀∀ form a reduction class and are therefore undecidable. First order predicate calculus, has its logic limit set quite low.

### Hilbert's 10th

The grand prize in mathematics was to provide an answer to Hilbert's 10^{th}. Do Diophantine equations have mechanical solutions. Much progress was made during the early parts of the 20^{th} century. For example, all linear Diophantine equations—equations with the form ax+by=c, where a, b and c are given integers are decidable. For problems over [symbol] it is easy to show that is decidable. The decidability of ² is unknown. In 1981 Jones proved that ∀ is decidable, but the following are undecidable ∀² (Matiyasevich), ²∀ (Matiyasevich-Robinson) and ∀², ∀³, ∀∀ (Jones). In 1975 Matiyasevich announced that ⁹ over [symbol] is undecidable, Jones gave a complete proof of this 9-unknowns theorem in 1982 in the Journal of Symbolic Logic. He also showed Diophantine Equations with less than eleven free variables over [symbol] are decidable but above that limit they are not.

The definition of a Diophantine equation is very simple: A polynomial equation containing two or more unknowns solvable with integer solutions.

P(x₁, . . . , xₙ)=0, xₙ∈

[symbol]

Example expansion . . .

ax+by²+cz²+du³+ev⁵ . . . =0

Some Diophantine equations are easily solved automatically, for example:

x, y(x²=y²), x&y∈

[symbol]

Any pair of integers will do, and a computer programmed to step through all the possible solutions will find one immediately at ‘1,1’. An analytical tool such as Mathematica, Mathcad or Maple would also immediately give symbolic solutions to this problem therefore these can be solved mechanically. But, Hilbert did not ask if ‘some’ equations could be solved, he asked if there was a general way to solve any Diophantine equation.

One way to think of Diophantine equations is as multi-dimensional surfaces and the integer solution as points where the surfaces intersect with each other and also the integer grid. Julia Robinson used this idea to develop an algebraic hypothesis for Diophantine equations, which, if proven correct, showed Diophantine equations were generally unsolvable. Despite thirty years of intense work, she and many other colleagues failed to complete the proof but each person managed to chip away at the problem. Finally, in 1970 Yuri Matiyasevich filled in the missing piece to show there is no general method to find the solution to a Diophantine equation.

The Matiyasevich Result (Strictly, he asked if there was way to tell if the equation was solvable, not what the solution might be. Most people assume the only way to tell if there is a solution is to show an example. Proving the opposite, that there can be no solution, requires a subtler argument.)
Theorem (Undecidability of Hilberts's tenth problem) There is no algorithm which, for an arbitrary exponential Diophantine Equation, would tell whether the equation has a solution or not.

There are two important points to make here.
1. There can be no algorithm that will find an algorithm to solve a non-computable problem. If there were such an algorithm that algorithm would itself be the algorithm that could solve a non-computable problem (By first finding an algorithm and then running it). Therefore, once you have concluded something is non-computable NO algorithmic process can help you find a solution. This puts a hard limit on learning algorithms. A learning algorithm may not learn a method by which it could solve a non-computable problem.
2. Un-decidability and therefore non-computability applies to individual ‘arbitrary’ equations taken from an infinite set, not only to sets of equations. This is an important piece of the Matiyasevich result as previously people thought undecidability only applied to sets of equations. (As stated early, for a single equation to be undecidable it must refer to some mater of mathematical principle and iterating over all the possibilities would be an infinite task. Finite problems are always decidable through the application of brute force.) This does not mean the equation is unsolvable nor does it mean there is no specific algorithm that can provide an answer but, there is no general way to find that specific answer.

### The Decidability of Fermat's Last Theorem

We can extend the results above to answer the question; could Fermat's Last Theorem be found by an algorithm. (This would also apply to an arbitrary Exponential Diophantine equation pulled from the set of all equations.)

Fermat's last theorem is an exponential Diophantine equation 1, an esoteric field normally confined to mathematicians, yet every school child knows at least one Diophantine equation by heart, “The square on the hypotenuse is equal to the sum of the squares on the other two sides”. Fermat's last theorem says there is no solution to this puzzle for cubes, hyper-cubes and so on up to infinity, “The cube on the hypotenuse is not equal to the sum of the cubes of the other two sides”, nor any similar higher order statement.

The theorem can be stated formally as:

∀n,x,y,z[˜(x+1)ⁿ⁺³+(y+1)ⁿ⁺³=(z+1)ⁿ⁺³]

Although this equation appears to have a prenex normal form of ∀⁴, suggesting we might known whether it is decidable, it cannot be analysed as a classical decision problem because it is not part of first order predicate calculus—it is an exponential Diophantine equation. For many centuries mathematicians did not know whether there was a proof of Fermat's conjecture, nor whether such a proof could be found with a mechanical procedure—something we now call ‘an algorithm’.

Matiyasevich result above does not let us tackle Fermat's last theorem directly because Pythagorean triples are only Diophantine for fixed n. FLT it is an exponential Diophantine equation. The n must be considered a variable and takes it into a different class of problem. In 1982 Ruohonen and Baxa prove Exponentiated Diophantine equations can be rewritten as a regular Diophantine equations with the addition of an infinite set of terms u₁, . . . , uₘ therefore:

xⁿ+yⁿ=zⁿ

is equivalent to

F(w+3, x+1, y+1, z, u₁, . . . , uₘ)=0

We now use the Jones-Matiyasevich proof that Diophantine equations with greater than nine terms in [symbol] are unsolvable. Since u₁, . . . , uₘ, represents an infinite set of terms exponential Diophantine equations and undecidable and therefore Fermat's Last Theorem has no decision procedure. We can state Matiyasevich's expanded result to say.
There is no algorithm which, for an arbitrary exponential Diophantine Equation, would tell whether the equation has a solution or not.

The discovery that exponential Diophantine equations have no general algorithmic solution turns out to be lucky for mathematicians—at least in the context of job security. Many problems have the same structure: Goldbach's conjecture, the Riemann hypothesis and the four-color conjecture to name a few. If it had gone the other way most mathematical problems could be solved with a single general mechanical procedure.

Earlier we described the difficulty in solving certain problems as a boundary but it might be better visualized it as bubbles. Once within a bubble you may automatically solve problems within that bubble but crossing from one bubble to another is not achievable through brute force computation. Bubbles have different sizes with the size corresponding to the extensibility of understanding within that bubble. Linear Diophantine equations are all contained in one big bubble: Once you understand the concepts of counting and logic they are all immediately available. Exponentiated Diophantine equations, on the other hand are more like foam. Each tiny bubble of knowledge gives solutions to its directly comparable problems but no more than that. For example, if we used x, y, z, w rather than x, y, z, n as the parameters in FLT it could be trivially solved but problems with just a single additional symbol in the right place are rendered outside the bubble and might take a life time to solve. Knowledge of a new area only gives access to that specific area and is in line with Turing's result for ordinal. An oracle for a problem only gives the answer to that problem and is subject to own halting problem.

### The Wiles Paradox

In 1995 Andrew Wiles announced he had found a proof of Fermat's Last Theorem. He had secretly been working on the problem since coming across the puzzle as a boy. His proof meant we now had the answers to both our questions: Fermat's last theorem is provable and no algorithm could have found this proof. This leads to a paradox: If no algorithm can have found a proof and humans are computers Wiles should not have been able to find a solution. It seems Andrew Wiles cannot, therefore, be a computer and by analogy human brains are not computers.

We conclude that human brains solve problems that computers cannot, in principle, solve and there would be benefit is collaboration between humans and computers. We also propose the capability that human intelligence uses to solve strictly non-computable problems also provides an explanation for the ability of human brains to solve technically computable problems with low computational, memory and power requirements and demonstrate how this can be employed in a practical system. We also argue that many creative tasks that cannot be proven to be non-computable are part of non-computable mathematics and demonstrate a method for testing this. Applying this test can then be used to assign tasks between human and artificial intelligence. We are not suggesting human intelligence is outside of the normal bounds of science but simply that it is a different mechanism than artificial intelligence. It should be possible to create human intelligence through the application of engineering principles. When we refer to human intelligence in this text we also mean synthetic forms of human intelligence—artificially created human intelligence that might be invented in the future. This is in contrast to our current form of artificial intelligence (AI) which is strictly computational artificial intelligence.

### PROBLEMS WITH CURRENT METHODS

Today's Artificial Intelligence suffers from a number of limitations. Artificial Intelligence (AI) often struggles with problems that Human Intelligence (HI) finds relatively easy, such as holding a conversation. AI can fail catastrophically when it strays outside its trained rule set (exceeds the logic limit). A failing AI may not be “aware” it is failing. Although AIs commonly calculate a certainty value for each decision they make it is possible for them to be certain they are right when they are absolutely wrong. Such AI failures can be annoying in non-critical situations such as customer support, or dangerous in critical situations such as medical diagnosis. A key problem with current systems is they are generally implemented as a batch process. AI systems fail when presented with new information and require off-line training and reprogramming to correct these failure modes. Training and exercising of the AI algorithms are separate processes and the training is done by skilled human specialists. A system is allowed to fail, then the specialists examine the failure data, build a better AI algorithm and put it back into the field.

AI systems adapted to work with humans need personal data about that human. Today such information is incomplete, fragmented and usually stored in third party databases associated with search engines, commerce engines and social media services. We propose that this information be encoded by humans into a database that describes how they would be represented by a Cen™—a cognitive entity. The database would comprise exceptions to the standard information held by a general database. A question such as ‘what would you like to drink’ would be answered differently by different humans and therefore different Cens™ representing humans. Building this exception database is the essence of generating a unique representation of a human intelligence and their innate skill. We propose that this data is of great personal value and should be stored locally in an encrypted manner and remotely by some distributed means such as Publius™ in a way that cannot be read by unauthorised bodies. Alternately the data could be distributed by domain such that information about human user's culinary preferences is stored in one database and locality and travel preferences another and so forth. These different stores would be keyed by different indexes to their actual user. By this means loss of security of one database would not jeopardise a person's privacy.
A Cen may present as a control mechanism, text based ‘bot’, a talking head, a full virtual human or even a full humanoid robot. It may represent a single human a group of humans, a corporation or a fictitious character. In each case the Cen will have rules as to when it can operate autonomously and when it needs to revert to its ‘owner’ for guidance.

There are a number of classes of problems that can be presented to an AI/Cen.
1. Known computably tractable, in that it is known (or reasonably expected) that a computation can solve any arbitrary member of the class of problem.
2. Known computably intractable, in that it is known (or reasonably expected) that a computation cannot solve any arbitrary member of the class of problem (for example, by having a very large number of possible computable solutions).
3. Known non-computable, in that it is known (or reasonably expected) that a computation cannot solve any arbitrary member of the class of problem.
4. Known un-provable, in that it is known (or reasonably expected) that a computation cannot prove or disprove the conjecture. For example, the continuum hypothesis using the Zermelo-Fraenkel set theory and the axiom of choice.
5. Unknown, no knowledge is available regarding the solvability of the problem.
6. We should also mention unknown, unknowns. Problems we have not yet thought to classify.

Problems may be moved from one class to another through the application of new techniques and sometimes a problem might be temporarily misclassified.

For a problem to be classified in the above types, some algorithm or sentience must have turned its attention to the problem. There may be problems which exist but for which no classification has been contemplated. Our present invention is aimed at augmenting AI with human intelligence for tackling problems of types 2 and 3 and also providing human oversight and input to handle previously unknown and novel problems that may present themselves to an AI however any problem may benefit from a combined intelligence approach.

Human Intelligence has advantages. Humans can often improvise on the fly to solve problems that they were not specifically trained or given the explicit procedure for. It should be noted that humans are poor at precise calculations, repeated tasks, memory and humans often apply generalized heuristics instead of exact rules to the detriment of success.

Humans can rapidly be trained to identify classes (often with a single example) and can operationally remember a very large range of items with what appears to be very few calculation steps. They can rapidly invoke and apply rules with highly abstract content (such as social appropriateness).

Human intelligence is characterized by the faculty of “understanding” where the human invokes a model of the real world with which they can reason about concepts in an abstract manner.

Most importantly, humans demonstrate creativity that is not present in AI systems. AIs can be programmed to use rules to create de novo items, such as a song or picture “in the style of” human examples, but do not create “new” rules. In most instances the proposal that this creativity could be implemented by an AI algorithm is hard to dispute (although we believe incorrect). However, in the field of mathematical creativity it is possible to show definitively that the solution to certain problems is non-computable. Items that have been mathematically determined to be non-computable are by definition not possible for current computing systems to create. Thus, the human created solution to Fermat's Last Theorem, which was shown to be non-computable, could never have been created by a digital computer. It is therefore a problem with current AI systems that there are certain classes of problems that they are unable to solve, in principle, without human help. Thus, an optimized combination of human intelligence with artificial intelligence will result in systems that can solve a broad range of problems beyond that solvable by one or the other.

### PRESENT INVENTION

The difference between human and artificial intelligence suggests that a specific means to link the two would result in perceptual, memory, reasoning and decision actions that will be faster and more reliable than actions from AI or HI individually. The invention described here will use techniques to determine when human intelligence should be invoked to assist artificial intelligence by way of a communications mechanism. Our system examines a problem, determines its likely computational class, determines approaches available to solving that class and determines the likelihood that the different forms of intelligence might be most appropriate to the task. It then proceeds to either complete the task with AI, to implement HI and AI when needed during processing steps or to completely give the task over to HI.

### BRIEF SUMMARY OF THE INVENTION

An artificial intelligence may cross the boundary of its competence without recognizing that boundary. Such an AI may use our system to determine if it is at risk of failure or has failed and allow humans to intervene, preferably pre-emptively—i.e. before any output is made. The characteristics of the data leading up to the detection of a potential or actual failure are recorded and the results of the human intervention are used to tag the data so that the system learns, and the need for future human intervention is less frequently and more accurately determined.

The system is presented with a data set from the real world in the form of a query. Such a query might be a natural language question, a string requiring translation or an image requiring a decision—such to brake or not to brake in an autonomous vehicle scenario. Queries may also be self-generated in response to the passage of time or the computational load of the system. In this case the query might appear as a self-generated decision to act.

In each case an AI system will processes the query data through an algorithm which might be a set of logical stochastic rules, a deep learning neural network or some other common AI technique.

For example, in natural language processing systems, rules might be used to break up the sound signal into short sections which are then converted to phonemes, words, sentences and finally logical queries. At each stage in this pipeline neural networks or logical reasoning might be applied to form the next data set in the pipeline. At the end of the pipe line the query is transformed to something for which a response can be readily made. That response might be correct, partially correct or wrong.

Our system applies algorithmic and deep learning neural nets to detecting potential failure based on abstract characterisation of the problems presented. Algorithms examine the query to determine which class it belongs to: Class 1 to 6 above. It might do this on an absolute basis or determine a probability for each class membership. If the class is tractable it may make an estimate of tractability or complexity. In the deep learned case, training and debugging of the neural network uses the training set of labelled examples described above to generate a fitness function (or in our case an unfitness function). Such a function characterizes problems as hard or easy for an AI and determines the likelihood of failure.

The development of this proceeds by presenting input data to both the normal AI function and our characterizer. Prior to any training our characterizer will be set at 0.5. With an output of 0.5 or below (‘unfit’), all input it sent to the human intelligence in addition to the AI. The HI scores the AI on its proposed output. The input, output and score represents a training set for the AI. The HI determines whether to override the output of the AI for each scored response.

In one embodiment, we distribute the calculation of this ‘unfitness’ function to a large number of human intelligences using a communication means. The human(s) monitor queries and answers to create a labelled set of cases where the artificial intelligence makes errors detected by one or more of the human moderators. Simultaneously we apply algorithmic and neural network approaches to characterize the queries into hard or easy, computable and non-computable. Matching the two allows us to train an ‘unfitness’ function.

Once the unfitness function has been initially created queries can be automatically tagged as likely to need human intervention. A proportion of low probability (>0.5 score) queries are still distributed for checking on a random basis to avoid accidental miss-training of the system. Also it should be pointed out that intervention may be triggered for ethical or legal reasons and not simply because an AI might fail to respond correctly. Therefore, when tagging data human moderators are asked to indicate the reason for intervention.

It is preferred that more than one human provides monitoring to the enabled AI system, however, in some cases, a single verified human is sufficient. Verified as expert can be by either formal vetting, historical information regarding reliability or peer review and recommendation.

In an alternate embodiment, we apply objective failure measures such as loss of a game, crashing of a vehicle, failure to grasp an object and others similar measure instead of or as well as human scoring. In these non-human monitored examples a human is still being brought in to correct the system and further tag the dataset. For example, if the AI system must throw a ball into a hoop detection of a miss might be automatic but in a more complex scenario the elegance of the dodging of adversaries or the formation of an attack strategy might be best tagged by human monitors.

There are two main scenarios where a system could employ human/artificial hybrid intelligence.
1. A system where a human user queries an AI and the operation of the AI is monitored by a human moderator.
2. A system where a machine queries an AI and is monitored by a human moderator (for example, financial trading systems).

There are hybrid scenarios such as human/machine hybrid interfacing with an AI and human moderator which will require a hybrid of the following solution description.

Queries might be using arbitrary data, protocols, voice, video, text, chat or other media and means of communication and control.

One effective and semi-automated method for detecting failure in human user, AI interactions involves examining the human user for signs of empathy and engagement with the AI. Such examination is done by applying emotional analysis tools to the responses of the human to the response of the AI, this can include detecting eye gaze patterns, time and subject synchrony of communication, physiological responses (such as heart rate) and emotional state declarations by the user. For example, we may detect that the human user's emotional state became unhappy by means of detection of voice and facial expression, followed by a lack of synchrony in the communication pattern (talking over the AI) and then the eye gaze directed off the screen. The eye property based method for quantifying emotions can be implemented with tools such as Emotion Tool™ a software tool that measures immediate human emotional responses to visual stimuli. These and other tools have well described APIs and can be readily integrated into our proposed system. Since the system learns as it goes, no particular initial setup is required. We match the user empathy to the AI algorithmic inputs and output and tag errors. This match between the emotional empathy of the user with the AI and the AI response both generates a tagged data set that we can use for training and provides an alert system to signal when a human moderator should intervene.

In other variations, the system when programmed and when trained to do so, uses the emotional valence data to pre-emptively request human assistance. The emotional variance detection system allows human moderators to modify the AI algorithm so that it no longer creates an error needing human assistance.

Using this multi-mode interaction and indication of human stress and engagement (voice, video, text, body position, heart rate variability, EEG and so on) we can train AI systems using humans, gradually reducing the need for human participation thus, passing the Turing test can be learnt in the limit.

For systems that will always need a human for safety and ethical concerns, we create a human/artificial Intelligence hybrid system that efficiently signals to the human moderator when their input is needed.

A variant of the system can work in reverse determining when a task is of a highly computational nature and direct it towards artificial intelligence means. The computation classification methods are symmetrical in that they will determine whether something is likely to be non-computable or likely to be computable allowing for direct of the task to the appropriate recourse.

An AI algorithm designed to respond to humans and monitor the empathy of the human upon that response is called a Cen™, (cognitive entity) in the rest of this specification. But a Cen does not have to be interacting with a human it may interact with machines or other Cens™. At its core, it is a repository for a set of intelligence linked to one or more human intelligences along with an understanding of the limits of its intelligence and an ability to call upon human intelligence for further guidance. Because of this match to one or more human intelligences a Cen may take action or answer queries on behalf of its human intelligence counterparts on an independent basis only asking for clarification when it detects the boundaries of its capability or authority.

A process for systematically identifying non-computable problems is now described which may aid in initial setup and training of characterisation system.
a) Assume much of what we do is in principle is not computable and in the class of non-recursive mathematics but is not analytically determinable.
b) Ask mathematicians to solve many non-computable word problems. (Even if some are computable we are assuming the brain developed a non-computable skill which it usually uses, we call this ‘intuition’.)
c) Find a cohort that can solve them at will.
d) EEG the brains of this cohort as they perform these tasks (a 128 channel EEG or better is needed for good results)
e) Have cohorts solve other problems and look for a similar pattern of EEG activity.
   i. Provide biofeedback to subjects to encourage them to use this pattern and be more creative.
   ii. Create classes of the types of solutions creative people come up with to apply to other areas.
f) Uses the classes of solutions in other fields
   i. Trading
   ii. Diagnosis
   iii. Teaching

### BENEFITS OF THE PRESENT INVENTION

1. Some problems are not computably solvable by a classically constructed digital computer implementing any form of algorithm. Since an AI is simply an algorithm these problems are not solvable by an AI. By utilizing human intelligence in combination with artificial intelligence our system is able to solve a broader range of problems.

2. Our system has considerably reduced power consumption for some problems. The human brain consumes around 30 watts to process language and vision into an integrated whole while modern state of the art natural language query systems run on supercomputers routinely consuming kilowatts.

3. Our system can solve a broad range of problems more rapidly and accurately.

4. Our system gives moral and legal oversight by humans over AIs.

5. Our system allows humans to precisely control the training of AIs on a continuing basis to avoid failure.

6. Our system encodes human knowledge in a safe distributed fashion while ascribing the value to individual humans.

### BRIEF DESCRIPTION OF THE SEVERAL VIEWS OF THE DRAWING

FIG. 1. Overview of System Components & Human skill marketplace

FIG. 2. A schematic section of the Interface

FIG. 3. System Diagram

FIG. 4. Classification of Problems into Computable and Non-Computable Classes

FIG. 5. Non-computable identification strategy

FIG. 6. Mathematical skills tester (deep learning neural net plus stochastic knowledge representation) and arrangement of AI blocks

FIG. 7. Model synthesis for collective AI training

### DETAILED DESCRIPTION OF THE INVENTION

The following detailed description serves to define example embodiments and does not, therefore, limit the scope of the invention, which is defined only by the appended claims.

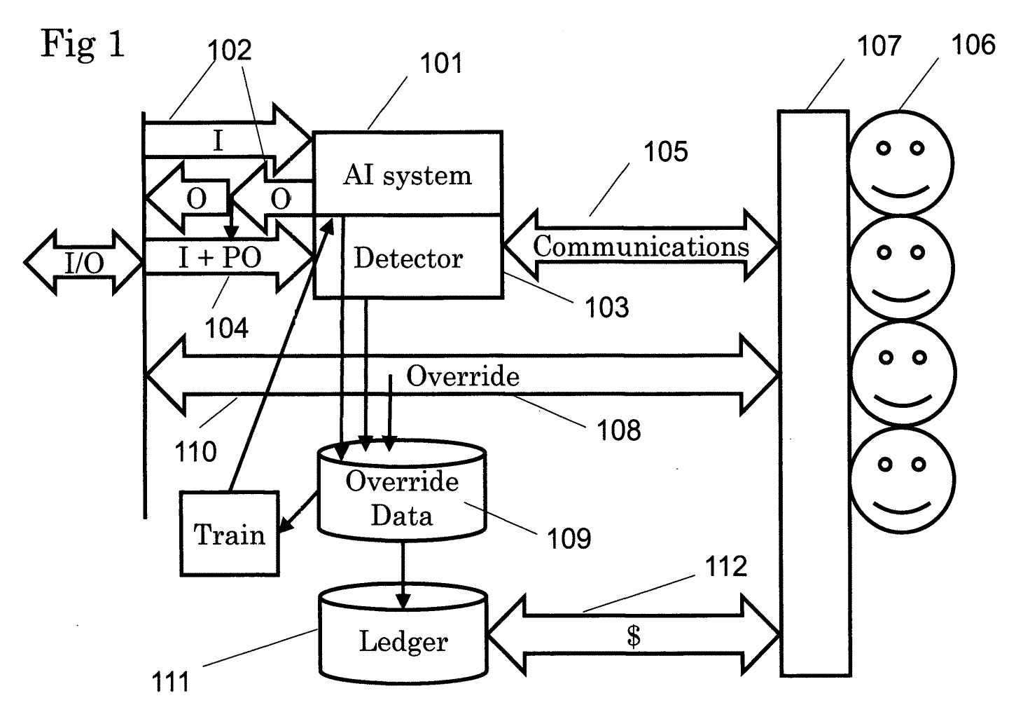

FIG. 1. Illustrates the main components of the system. An AI system 101 is capable of input, processing and proposing output by way of an I/O channel 102. The output channel is controllable so that information is presented to the detector prior to final output. The detector 103 has a copy of the input 104 and proposed output from the AI system and is capable of characterising input and proposed output of data. The detector is closely coupled to the AI system and is further capable of directly reading internal states of the AI system. The detector is capable of assessing likely failure of that AI system or other need for intervention (such as legal or moral oversight) by characterising the input as difficult for the AI to correctly process by way of algorithmic means implemented in logic or by a deep learning neural network. A communication means 105 is available to the detector allowing notification to and oversight by human moderators 106 upon determination by the characterisation means that such oversight or intervention may be necessary. One human intelligence or a bank of human intelligence moderators may be queried via a scheduling means 107, a means to override the proposed output of the AI is provided by an override line from the human moderators to the I/O plane 108. A store of data 109 to records the override and the condition of the AI system and detector system leading to this override. This override data is used in the future to allows the AI to better perform its job via a bi-directional connection to the override data. Further a training means 110 is provided to use the override data to make permanent changes to the AI algorithm. A recording means 111 implemented by a ledger or block chain records the intervention by individual human moderators and the resulting training of the AI and records the value of this human input. Upon future operation of the AI the human moderators can be rewarded 112 for their valuable past input and ongoing oversight. Moderators join the human skills scheduling unit 107 to form a community of suppliers rather like a system such as Wikipedia, Mechanical Turk or Uber. Participation in this HI/AI hybrid can be on an open basis. A user can log in and add their HI to an AI task, building a community and user/supplier base. The moderators train the AI and catch errors. In one scheme of compensation, the more they train, the more value they earn in the ledger 111, giving them rights to a share in future revenue generated by the AI version of themselves. Moderators are also paid for error correction work when they override the system 108 and providing general oversight by logging into the scheduling engine 107. For many tasks, human input is always needed for reasons of ethics, safety, oversight and the assumption that the AIs will always struggle with new scenarios. In a preferred embodiment, we target high value problems such as medical diagnosis, financial trading, legal analysis, insurance risk analysis and counselling which involve high monetary values per hour. The communication means can be implemented using Freeswitch Verto Communicator to provide registration and communication or by Matrix.org.

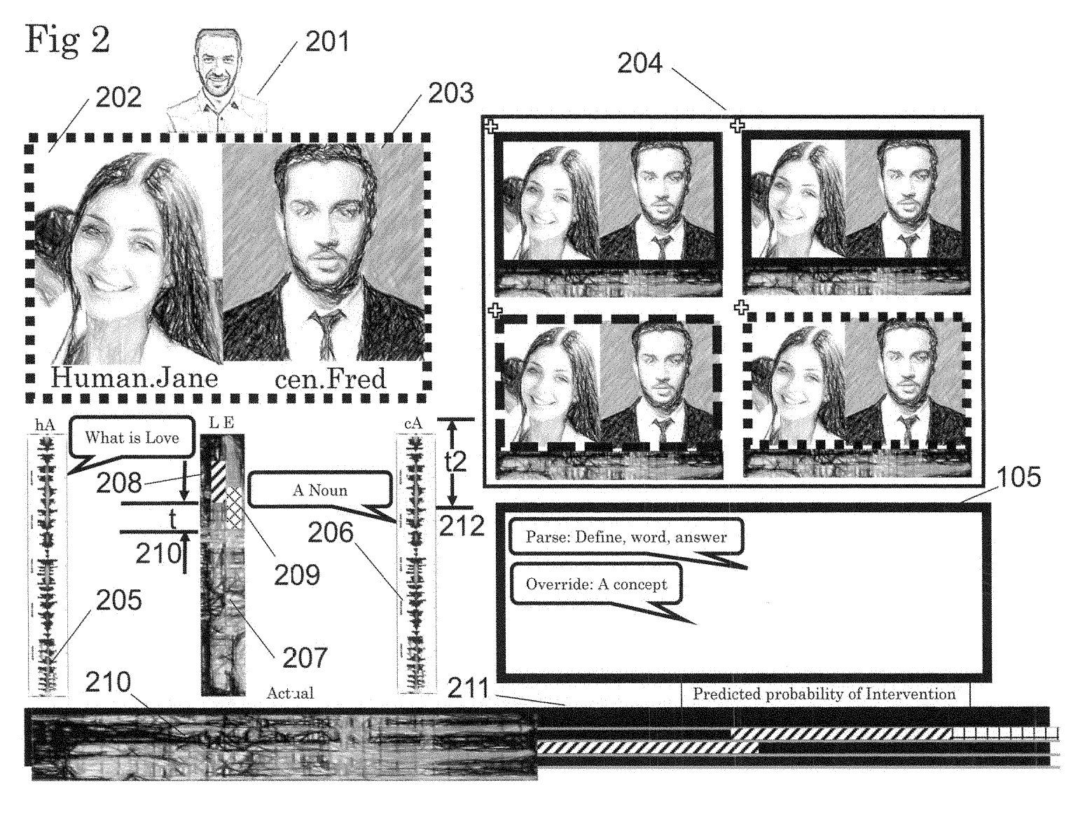

FIG. 2. Illustrates an interface screen where a human moderator 201 directly monitors the interaction between a human user 202 and an AI driven cognitive engine Cen™ 203. A key feature of this interface is that a single human user (or bank of users) can monitor multiple human cen™ interactions however the interface screen is from the point of view of one individual human moderator, moderating multiple human-cen interactions. The Cen 203 is giving information to, advising or taking action on behalf of the human users 202. The moderator 201 is a domain expert in the field for which the human user is enquiring. The moderator can monitor many conversations, four are pictured in the right panel 204 but more or fewer could be handled depending on the complexity of the task. Variant forms of interface screen could be used for large monitors and for small mobile displays using common web design paradigms. In one variant, the moderator can see the conversation as it transpires in audio and transcribed form 205, 206 and see a heat map 207 of the interaction between human users and the respective instance of a cen. The basic heat map shows two pieces of information, the complexity 208 of the problem being asked by the human based on a complexity measure and the empathy between the user and the cen based on an empathy measure 209. The empathy measure and complexity measure are calculated in real time by algorithms described below. The human user is also able to call for help or signal that they are uncomfortable with the conversation using an explicit feedback mechanism (not shown as this is the moderator view but imagined as an escape key) or the implicit feedback mechanism of empathy 209. Finally, the transaction time t 210 is monitored to detect how quickly a given requested action is executed. The two measures, logic 208 and empathy 209 allow the interface/agent to build a picture of the quality of interaction, detect when the moderator needs to step in and monitor the speed of interaction.

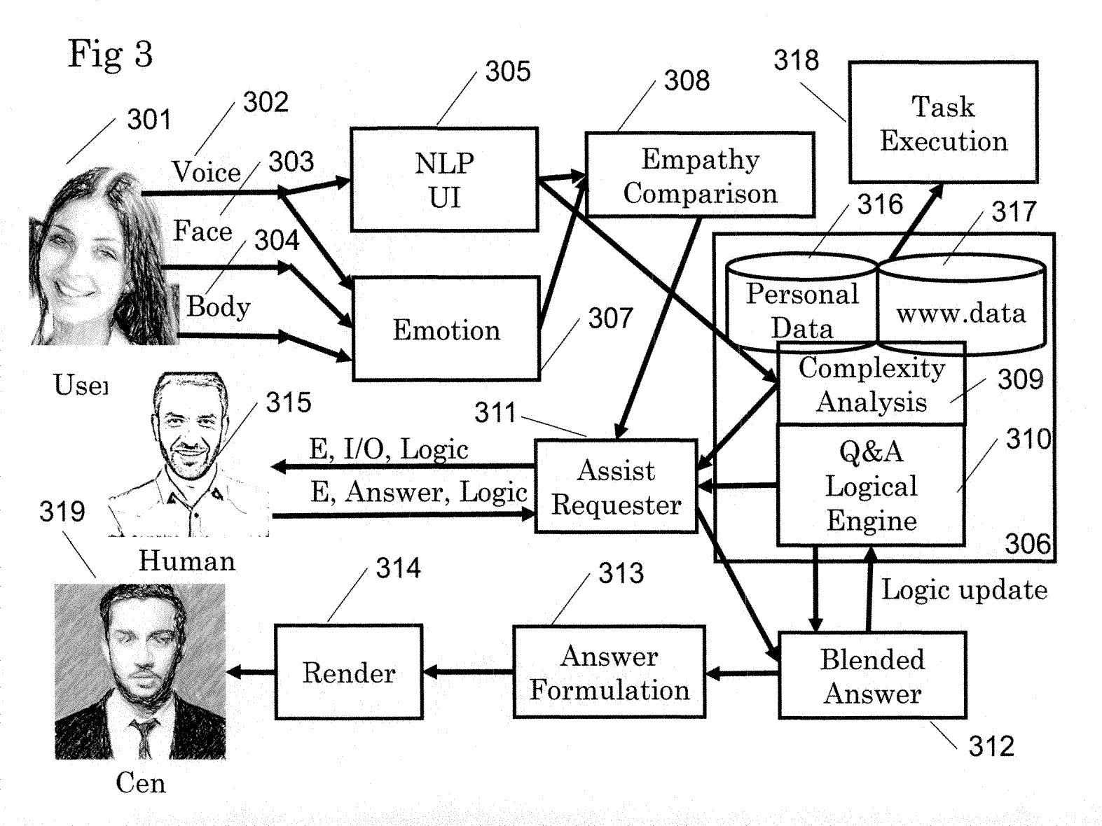

In operation, the interface agent (not shown in this diagram but whose essential operation is depicted in FIG. 1 as 103 and will be described in more detail in FIG. 3) detects conditions are critical such that the moderator is required to step in. The AI powered Cen 203 has failed to understand or is giving incorrect answers or has lost the attention of the human user 202. Ideally the logical detector/characterisation means shown as 208 detects and displays in advance of any output so the human moderator can make corrections such that the interaction between the user 202 and the cen 203 is seamless. In ideal operation, the Cen-operator combination passes the Turing test by imitation of a human alone as the human fills in any gaps in the system response repertoire so that the system always responds in a sensible way. In this way, the cen is able to ‘force multiply’ and improve the efficiency of the human moderator to serve several humans using multiple Cens™ 204 as mediators. The scheduling agent can perform a many to many mapping between users, cens™ and moderators where the usual case is that there will be more users than moderators. It is possible, particularly in machine cases that there might be only one machine but many operators. This might be the case where ‘the wisdom of crowds’ is required such as in complex decision making scenarios such as stock trading et. al.

The interface presented in FIG. 2 displays the output of a number of key system components; logical complexity analyser, empathy analyser and intervention scheduler.

The logical detector/characterisation means performs failure detection by employing an algorithm, which looks at a number of factors. These include: the domain of knowledge in question, the algorithmic complexity of the logical stochastic model on a computable and non-computable basis and the subsequent empathy measure of similar transactions in the past. This logical complexity forms a heat map 208 for a given conversation and a series of stacked heat maps 211. Other representations of the logical complexity are possible.

The terms detector, characterisation mean, unfitness function and complexity analysis function can be used interchangeably. The essence of these terms is that a functional block takes as input the information presented to the AI and calculates the likelihood that the output given by the AI needs to be augmented by human intelligence. The different terms are used in this specification to aid readability in the different contexts. The function can be built analytically or learnt by a deep learning neural network procedure or even be implemented by the bank of moderators themselves. In the analytical case a system such OpenCog deconstructs the problem into its predicate logic representation. The representation is converted to prenex normal form and compared with a database of known non-computable patterns. Additionally, a complexity score is calculated based on the number of logical inferences needed to derive a solution. In a deep learning neural network system the predicate logic representation is used to train a neural network using the Torch or Tensor Flow framework to recognise non-computable patterns. Implementation of a standard classification framework in either system with a reasonable number of hidden layers (15 or more) will render a useable system. Since the conversion to prenex normal form is simply an algorithm it is permissible to train the system on raw data with a large enough dataset and without explicit deconstruction to logical form. Because of the generalisation of failure many input sets may be used from different problem domains, for example may language, many images, many queries.

The intervention scheduler (not depicted in this interface diagram but represented in 107) keeps track of the different conversations and their intervention pattern score and displays them 211 so that the intervention scheduler can flag which conversation the human needs to intervene in. This is done by setting a threshold at which human moderation is requested. If the human would be conflicted—needing to enter more than one conversation at the same time (shown by the overlapping cross hatched sections in 211), the intervention scheduler can delay or re-order communications to avoid a clash. The intervention can be done by inserting padding text into the conversation such as ‘let me think for a moment’ thus ‘buying time’ for the human to intervene. The intervention scheduler may also call on other humans with relevant skills in the pool via the human moderator scheduler 106. The scheduler can be simply implemented by two tables where each row in the first is a human user and each rom in the second is moderator and then assigning moderators to users on a first come first served basis. As moderators become free they are assigned to the next human user.

The empathy measure 207 is calculated using a mixture of gaze, body language or tone of voice. For example, there exist tone of voice detection system such as systems produced by the company BeyondVerbal that detect the emotional content of the speaker. This system will output information indicating that a human user is getting annoyed, exasperated and or otherwise inappropriately responding to the AI. An empathy measure is calculated by comparing the emotional state of the user to the expected emotional state of the user given the topic under discussion. If the states to not match or the human state is considerably more negative than the subject matter, then this gives a low empathy score in proportion to the mismatch. When these inappropriate responses occur the heat map activates a prompt for the moderator 209 illustrated by the hatched region in the diagram. A data set tag is generated and stored in the override data store 109 to show that this sort of question and this sort of complexity result in a user subsequently becoming inappropriately engaged. Thus, in future, interactions of this pattern will warn the human moderator in advance that intervention may be needed.

In alternative embodiments, biological inputs such as pupil dilation, heart rate variability, skin resistance and breathing can provide implicit feedback 304 which can be integrated into the empathy measure 207 improving the system reliability in reporting the user's comfort level with the interaction. Such markers are correlated with subsequent transactional success and their utility in the process determined.

Transaction time t2 212 can be measured from the moment a question or request is made to the point at which a satisfactory answer is given. The transaction time is used as one possible measure of success/fitness.

A single human moderator 201 can monitor many transactions in a multi-pane window 204 or by way of the stacked heat map 211. The stacked heat map represents each conversation stream as a row where the colour changes as intervention becomes more likely to be needed or is explicitly requested. In the case of a human moderator using a mobile platform, the stacked heat map or similar abstraction may be the only way to see multiple users on a small display. When a transaction indicates failure may be approaching because the map is turning red 207, 209 the human moderator can step in. When the human moderator realises that they must intervene they can expand the size one of the interactions to the main display on the left. (It is possible that a moderator could have more than one focus window but in general humans are single tasking entities.) The moderator can see video 202, 203, hear and see audio 205, 206 and see the natural language parser text generated by the AI in original language or translation examples of which might be ‘what is love’, ‘A Noun’. The moderating human 201 has information on the logical complexity of the transaction 208 and the emotional empathy in the transaction 209. The emotional empathy features displayed can include tone of voice as well as face and body language cues and biometric information.

Human moderators 201 can override the cen at a number of points but does so in two main methods. One approach is before a response is given by the AI any time in 208, using one of the predictive methods to indicate early intervention is needed and the other is after the AI response 212 is provided, using a responsive indicator such as the emotional response of the user 209. The ‘late response’ after the AI is not optimal. However, in the system data store 109, late responses are recorded to create a training set to allow early responses detection to be implemented. The system learns from these late response interventions so as to avoid them in the future.

The moderator can override the AI cen response:
a) In Background (called ‘puppeting’)
   i) By answering the human question as if they are the avatar
   ii) By improving or modifying the AI logical model or providing missing data
b) In the open foreground where the moderator inserts their voice, image or both into the communication stream replacing the cen 203. Such an open intervention is rather like the situation where a manager, supervisor or consultant steps into handle a question. If the cen is built on a model of the actual human moderator and only one moderator is permitted to intervene this might be almost seamless.

In an alternative embodiment, the human user is replaced by some arbitrary problem which represents itself through audio, visual and text cues. For example, the human user could be replaced by the image of a traffic or by a stock market trading screen. In each case the empathy function (which is in truth a fitness function for correct response by the AI) is modified to present an index of an abstract value. Examples include: distance between vehicles and maximum breaking speed or losses and volatility of financial portfolios. In our system, the essential component is the detector of complexity/non-computability analysis measurement to the normal process of and AI such that humans can be brought into the process in real time. This detector 103 is in FIG. 1.

FIG. 3. Illustrates the information flows within the human-artificial intelligence hybrid system when working with a human user. The user 301 transmits their information through facial image 303, voice audio 302 or body information by way of; motion capture, typed text, touchscreen input or biometric data 304 to two systems. The first is an AI pipeline of natural language parsing (NLP) or traditional screen UI 305 leading to an algorithmic engine block 306 and the second system an emotion detector 307. The logical engine block 306 is comprised of several subsystems; personal data 316, world wide web general data 317, a complexity analyses characteriser 309 and Q&A logic capable of answering queries 310. If the systems determine an action must be taken they can execute a task via the task execution module which is capable of general purpose output and interfacing with third party APIs 318.

The NLP question is posed to the algorithmic engine 306 and its complexity is analysed by a characteriser 309. The complexity analysis uses algorithmic and neural network based methods to determine whether the question is likely to be answered in a satisfactory way by the AI. The AI logical engine 310 (which may be comprised of a range of AI techniques) then attempts to answer the question. It is a feature of this invention that the nature of the AI engine for which we are estimating failure does not need to be known. Upon communication by the Cen to the human user their emotional state is detected emotion engine 307. An empathy comparison 308 is made of the users tone of voice and other non-linguistic cues (such as gaze attention and body position) to determine whether the human user is engaged with the cen 319 (the representation of the AI to the user). The complexity analysis function 309 produces a ‘likelihood’ measure of the percentage accuracy of the AI answer and also whether there might be other reason for needing human intervention. Thus, the system is in possession of two pieces of information indicating the probability that the AI is correctly serving the needs of the user, the empathy measure 308 and the logical complexity measure 309. The assist requester 311 combines these two measures to determine whether intervention by the moderator is required and a blended answer is generated 312, formulated 313 and rendered 314. Alternately the human moderator 315 can replace the cen 319 entirely.

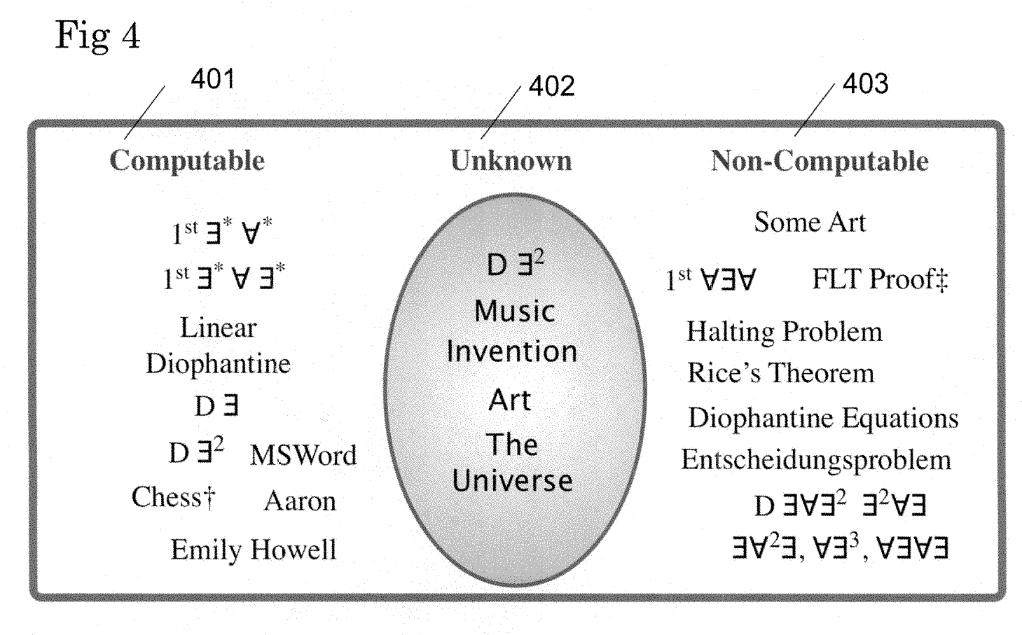

FIG. 4. Turning now to the underlying mathematics that allows for detection of probable AI failure we wish to characterise problems into strictly computable and non-computable classes. The known classification of problems into computable and non-computable classes is illustrated. Other than for certain precisely defined areas of mathematics the classification of most problems we wish to examine are unknown. Some classes of problems are known to be computable 401 some are known to be non-computable 403 while the status of many problems of interest is unknown 402. As AIs are computations one area where certain failure of an AI system will occur is in problem sets which are by definition non-computable. These problem sets will occur in many domains. In some mathematical domains, non-computability can be demonstrated by reduction to a currently known non-computable problem via use of a theorem provers such as Vampire. In other more general domains where formal algorithms are incomplete or have only probability estimates associated, a neural network employing deep learning is trained upon know non-computable problems or problems that practically speaking result in a failure by and AI.

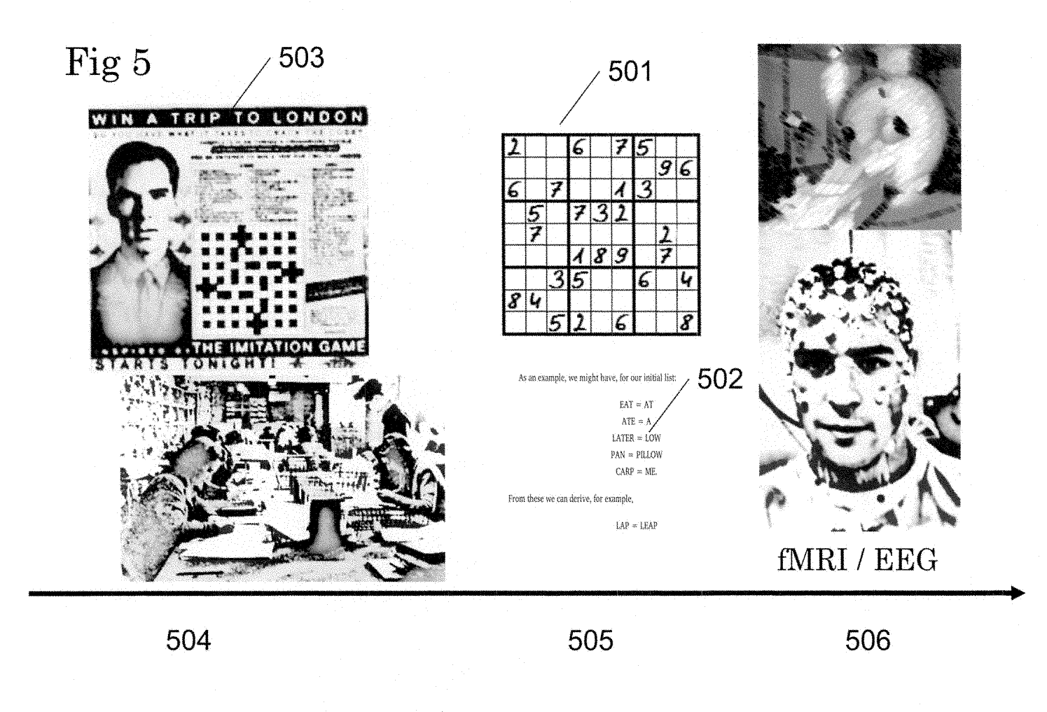

FIG. 5. One method for determining the difference between AI tractable problems and HI tractable problems is by comparing human responses to puzzles from computable and non-computable sets, for example Sudoku 501 and the word problem for semi-groups 502. A means to recruit good human puzzle solvers is needed and the same method can be deployed as was used for recruiting code breakers in World War II, namely advertising for them in The Telegraph (or similar news media) to solve different types of puzzle 503. The best puzzles to divide people with good human intelligence from people with ordinary (computable) puzzle solving skills are non-computable puzzles. A commonly used non-computable puzzle is a word puzzle: the work problem for semi-groups. In this puzzle, there is an origin word, a destination word and a series of permitted substitutions. The objective is to see if one word can be transformed to another using a simple set of substitution rules. In the word puzzle, positive solutions can be found through computation but negative solutions are non-computable. There is no general algorithm for showing why one word can NOT be transformed into another provided that the set of substitute rules is sufficiently complex. In order for humans to solve these problem, and explain why there is no solution, they must exercise creative insight. Some human subjects are able to do this efficiently. Having a cohort of such people and a series of non-computable tasks for them to perform enables human brain activity measurements to train the system to recognize AI intractable problems.

The process of finding and studying people who can definitively execute non-computable tasks proceeds as follows.
1. Recruit people who can solve non-computable puzzles in a similar fashion to the way code breakers were recruited in World War II by posing puzzles in newspapers on the web and in puzzle books 504.
2. Offering them a combination of computable and non-computable puzzles to work on. 505
3. For those people who show an aptitude for solving non-computable puzzles invite them to solve puzzles while being monitored. During solution activities, measure their brain activities using MEG, EEG, fMRI and other technologies to see which areas of the brain are involved. 506

Measure the brain areas during solution activities with carefully constructed mathematical puzzles designed to encourage the brain into creative mode. These puzzles appear similar to crossword or Sudoku puzzles that one finds in newspapers but are designed to foil computational approaches. By watching the human brain as it tackles such problems and also questioning subjects while we get insight into the operation of the human brain and the tricks it uses to short-cut computational complexity. These insights are applied to create Augmented Intelligence (AᵤI), the combination of HI and AI, that helps solve creative problems and enhances and amplifies human creativity. We can then present unknown problems to humans and if the MEG, EEG, fMRI signatures match those we have a reasonable basis to assume these tasks are also non-computable or that the structures in the brain able to solve non-computable tasks are also useful in these cases. By monitoring the brains of human subjects as they tackle known non-computable problems using EEG, MEG and fMRI signatures for known non-computable problems are extracted. Activities such as the composition of music can be monitor to determine if and when they are employing non-computation brain modes. A deep learning AI algorithm detects when a non-computable task is being attempted and requests human intervention or help.

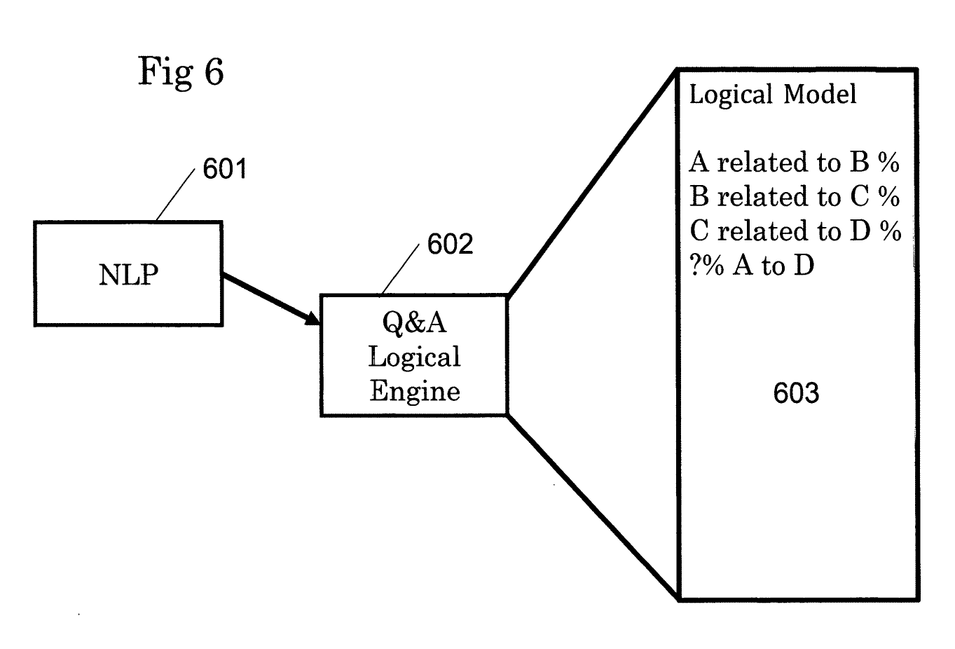

FIG. 6. Illustrates schematically the nature of a stochastic logical model inside a typical AI engine such as Opencog.org. The AI engine 602 forms a model of the question in probabilistic predicate logic, often with probabilistic weights 603 against each inference. A most likely overall inference (answer) is generated along with less likely answers. A direct measure of likelihood that the answer is correct can be ascertained from examining the AI algorithm's self-estimate of correctness. A second measure of likelihood can be ascertained by comparing the pattern of the logical inference map with previous examples that have resulted in correct and incorrect answer inferences.

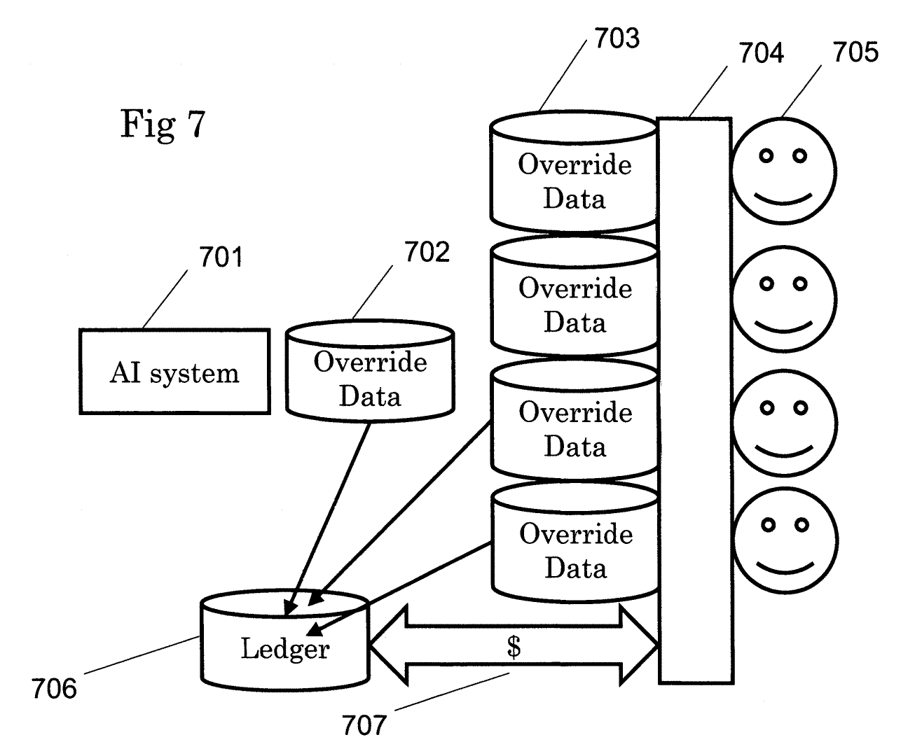

FIG. 7 illustrates a model for synthesis of collective AI training. In a general AI system 701 using our system, the answers given by individual human moderators 705 might be different. At any given time, the system 704 will be maintaining a set of override data for each user 703 as well as common override data 702. The ledger 706 uses information from the different stores of override data 702 & 703 to calculate the recompense 707 due to individual human moderators. The system dynamically updates the common and separate override stores over time. (One might also implement the system as a series of AI modules that have been trained by the override data and no long need to be overridden without loss of generality.)

In an alternative embodiment, a synthetic human brain could be employed that mimics or models the non-computable capability of the human brain to substitute for the human moderator.

In an alternative embodiment, elements of synthetic human brain could be employed to augment the AI without substituting for the human moderator.

In an alternative embodiment, human neurons interfaced by way of electronic means could be employed to augment the AI instead of a human moderator.

The Reading of this Specification

A portion of the disclosure of this patent document contains material to which the claim of copyright protection is made. No objection is made to the facsimile reproduction by any person of the patent document or the patent disclosure, as it appears in the U.S. Patent and Trademark Office file or records, but the owner reserves all other rights.

The words ‘and’, and ‘or’ may be replaced with and/or where this reading is natural.

Any term stated in the singular or plural may be replaced with the plural or singular where this reading is natural.

We claim:

1. An Artificial Intelligence (AI) system, comprising:
a characterization means.

2. An Artificial Intelligence (AI) system comprising a characterization means of claim 1, wherein human intervention determined by the characterization means can affect modification of the AI action.

3. An Artificial Intelligence (AI) system comprising a characterization means of claim 1, wherein human intervention can be effected in advance of the AI output.

4. An Artificial Intelligence (AI) system comprising a characterization means of claim 1, wherein
an input is presented to the artificial intelligence,
the same input is presented to a characterization means,
the characterization means determines whether human assistance is required,
the assistance of a human moderator or moderators is obtained way of a communication means,
the human moderator helps in the analysis of the input and generation of a resultant output,
the AI answer is overridden by the resulting output,
the fitness of this output is determined,
the characterization means is improved to maximise this fitness.

5. A system as claimed in 1 wherein the human moderator assistance determined by the characterization means is obtained in advance the final output being presented.

6. A system as claimed in 1 wherein multiple human moderator's assistance determined by the characterization means is obtained via a scheduler.

7. A system as claimed in 1 wherein the characterization means is a neural network.

8. A system as claimed in 1 wherein the characterization means is one or more human moderators linked to the system by a communication means.

9. A system as claimed in 1 wherein improvements to the AI or characterization means caused by the inputs of one or more humans moderator are recorded in a ledger so that the human moderator(s) receives ongoing financial payments for their previous beneficial input.

10. A system as claimed in 1 wherein responses given by a human moderator and utilised by an AI are encoded in a secure distributed repository such that no one copy of the repository can be used to regenerate an overall picture of the preferences and knowledge of an individual human.

11. A system as claimed in 1 wherein the system can respond seamlessly to natural language questions of a human subject by;
characterization of queries needing human assistance,
passing of those queries to a human moderator for response via a communication means,
responding in real time to those queries,
detecting failures of the combined response strategy by measuring the empathy of the human subject,
improving the characterization means so that future queries are correctly characterized.

12. A system as claimed in 1 wherein the characterisation is performed by first converting the logical form of a query into prenex normal form and comparing it with a database of known non-computable forms.

13. A system as claimed in 1 wherein the characterisation of non-computability is effected by reducing the problem to an exponential Diophantine equation.

14. A method for improving creative thinking comprising;
monitoring human subjects as they successful perform non-computable tasks,
imaging the brain of the human subjects to determine a pattern indicative of creative thought,
providing biofeedback to human subjects as they tackle tasks to encourage them to generate similar patterns.

15. A method for improving creative thinking as claimed in 14 wherein subjects can be identified as having exceptional creative insight and/or intuition.

16. A system comprising Artificial Intelligence (AI) and Human Intelligence (HI) capable of solving problems that are not solvable by either alone.

17. A system comprising AI and HI that is capable of solving problems that are not solvable by either alone of claim 16, wherein a characterisation means determines when assistance of the complimentary intelligence is required.

18. A system comprising AI and HI that is capable of solving problems that are not solvable by either alone of claim 16, wherein a characterisation means determines when assistance of the complimentary intelligence is required and that means is a deep learning neural network.

19. A system comprising AI and HI that is capable of solving problems that are not solvable by either alone of claim 16, wherein a characterisation means determines when assistance of the complimentary intelligence is required and that means is a logical complexity characteriser.

20. A system comprising AI and HI that is capable of solving problems that are not solvable by either alone of claim 16, wherein the problem is to learn.
